(19) United States
(12) Patent Application Publication
(10) Pub. No.: US 2023/0244728 A1
(43) Pub. Date: Aug. 3, 2023

(54) INTERRUPTING INFORMATION CASCADES

(71) Applicant: Federal Data Systems LLC, Columbia, MD (US)

(72) Inventor: Joshua S. WHITE, Ilion, NY (US)

(73) Assignee: Federal Data Systems LLC, Columbia, MD (US)

(21) Appl. No.: 17/591,676

(22) Filed: Feb. 3, 2022

(51) Int. Cl. G06F 16/9535

(52) U.S. Cl. CPC G06F 16/9535

(57) ABSTRACT

A method for analyzing data in a social network. A social graph for a user account associated with a social network is created. A social score for the user account is determined to be above a threshold, and a participation score for the user account is generated based on data associated with previous information spread events in the social network. An impact score for the user account is calculated based on the social and participation scores for the user account. A state model for a future information spread event in the social network is constructed and then run with and without the user account present. A comparison is made between the flows of information through the social network with and without the user account present in the state model, and a determination is made as to whether a difference between the flows of information satisfies a predetermined condition.

### TECHNICAL FIELD

The present disclosure relates generally to analyzing online social networks and, more particularly, to analyzing and disrupting the spread of information through social networks.

### BACKGROUND

While television, radio, newspapers, and other forms of broadcast and print media continue to serve as primary sources of information, many individuals and entities now turn to digital media, particularly the Internet and social networks, to share information. In the context of social media, information often flows in the form of cascades. When people or entities are connected by a network, such as a social network, it becomes possible for them to influence each other's decisions and behaviors. An information cascade occurs when a user changes their behavior based on inferences they make by observing other users. For example, a user may decide to share information that they might not otherwise share simply because another user who they are connected to initially shared the information with them.

Information cascades are the basis for all major information spread that occurs on social media. While in many instances information cascades serve to quickly spread useful, relevant, and important information, information cascades are also used to disseminate false narrative, occasionally with the goal of inciting violence and/or distrust.

### SUMMARY

The following introduces a selection of concepts in a simplified form in order to provide a foundational understanding of some aspects of the present disclosure. The following is not an extensive overview of the disclosure, and is not intended to identify key or critical elements of the disclosure or to delineate the scope of the disclosure. The following merely provides an overview for some of the concepts of the disclosure as an introduction to the more detailed description provided thereafter.

In an embodiment, a method for analyzing data in a social network comprises: creating a social graph for a user account associated with a social network; determining that a social score for the user account is above a threshold score, where the social score for the user account is based on the social graph created for the user account; generating a participation score for the user account based on data associated with one or more previous information spread events in the social network; calculating an impact score for the user account based on the social score for the user account and the participation score for the user account; constructing a state model for a future information spread event in the social network, where the state model is based on the one or more previous information spread events in the social network; running the state model (i) with the user account present and (ii) without the user account present; comparing a flow of information through the social network with the user account present in the state model to a flow of information through the social network without the user account present in the state model; and determining whether a difference between (i) the flow of information through the social network with the user account present in the state model and (ii) the flow of information through the social network without the user account present in the state model satisfies a predetermined condition.

According to an embodiment, a system comprises data processing hardware and memory hardware in communication with the data processing hardware and storing instructions that when executed on the data processing hardware cause the data processing hardware to perform operations including: creating a social graph for a user account associated with a social network; determining that a social score for the user account is above a threshold score, where the social score for the user account is based on the social graph created for the user account; generating a participation score for the user account based on data associated with one or more previous information spread events in the social network; calculating an impact score for the user account based on the social score for the user account and the participation score for the user account; constructing a state model for a future information spread event in the social network, where the state model is based on the one or more previous information spread events in the social network; running the state model (i) with the user account present and (ii) without the user account present; comparing a flow of information through the social network with the user account present in the state model to a flow of information through the social network without the user account present in the state model; and determining whether a difference between (i) the flow of information through the social network with the user account present in the state model and (ii) the flow of information through the social network without the user account present in the state model satisfies a predetermined condition.

According to another embodiment, a non-transitory computer-readable storage medium includes instructions that, when executed by at least one processor of a computing device, cause the computing device to perform operations comprising: creating a social graph for a user account associated with a social network; determining that a social score for the user account is above a threshold score, where the social score for the user account is based on the social graph created for the user account; generating a participation score for the user account based on data associated with one or more previous information spread events in the social network; calculating an impact score for the user account based on the social score for the user account and the participation score for the user account; constructing a state model for a future information spread event in the social network, where the state model is based on the one or more previous information spread events in the social network; running the state model (i) with the user account present and (ii) without the user account present; comparing a flow of information through the social network with the user account present in the state model to a flow of information through the social network without the user account present in the state model; and determining whether a difference between (i) the flow of information through the social network with the user account present in the state model and (ii) the flow of information through the social network without the user account present in the state model satisfies a predetermined condition.

Further scope of applicability of the systems, methods, and apparatus of the present disclosure will become apparent from the more detailed description given below. However, it should be understood that while specific examples indicating embodiments of the systems, methods, and apparatus, are given by way of illustration only, since various changes and modifications within the spirit and scope of the concepts disclosed herein will become apparent to those skilled in the art from the following detailed description.

### BRIEF DESCRIPTION OF THE DRAWINGS

Features of the present systems and techniques may be best understood from the following detailed description taken in conjunction with the accompanying drawings of which:

FIG. 1 is an example of a networking environment in which various embodiments of the disclosure may be employed.

FIG. 2 is a block diagram of a computing device according to an embodiment.

FIG. 3 is a diagram illustrating an example social graph structure, according to an embodiment.

FIGS. 4A and 4B are diagrams illustrating example sequences and information paths in an information spread event, according to an embodiment.

FIGS. 5A-5F are graphical representations of actor types within a social network, according to an embodiment.

FIG. 6 is a diagram illustrating an example observed information spread event, according to an embodiment.

FIG. 7 is a diagram illustrating an example information spread event with interruption, according to an embodiment.

FIG. 8 is a flowchart illustrating an example method for analyzing data in a social network, according to an embodiment.

The headings provided herein are for convenience only and do not necessarily affect the scope or meaning of what is claimed in the present disclosure.

Embodiments of the present disclosure and their advantages are best understood by referring to the detailed description that follows. It should be appreciated that like reference numbers are used to identify like elements illustrated in one or more of the figures, wherein showings therein are for purposes of illustrating embodiments of the present disclosure and not for purposes of limiting the same.

### DETAILED DESCRIPTION

Various examples and embodiments of the present disclosure will now be described. The following description provides specific details for a thorough understanding and enabling description of these examples. One of ordinary skill in the relevant art will understand, however, that one or more embodiments described herein may be practiced without many of these details. Likewise, one skilled in the relevant art will also understand that one or more embodiments of the present disclosure can include other features and/or functions not described in detail herein. Additionally, some well-known structures or functions may not be shown or described in detail below, so as to avoid unnecessarily obscuring the relevant description. It is originally intended to combine the configurations described in the various embodiments as appropriate. Also, one or more of the components in the embodiments disclosed herein may not be used.

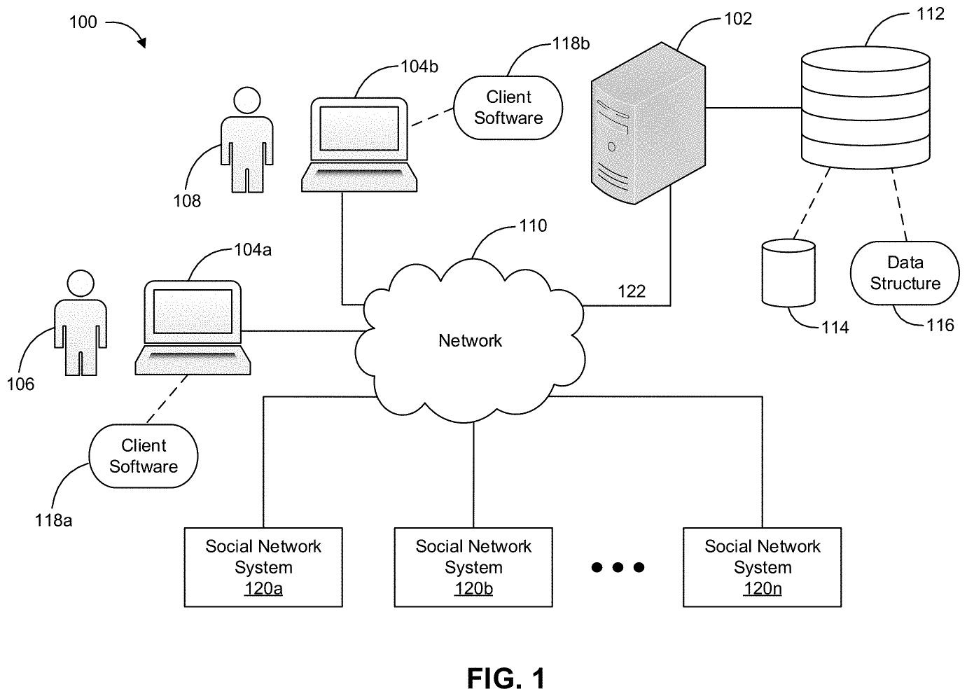

Various embodiments of the disclosure are implemented in a computer networking environment. Turning to FIG. 1, an example of such an environment is shown. A first computing device 102 is communicatively linked to a network 110. Possible implementations of the network 110 include a local-area network, a wide-area network, a private network, a public network (e.g., the Internet), or any combination of these. The network 110 may include both wired and wireless components. The first computing device 102 is communicatively linked to a media storage device 112 (e.g., a redundant array of independent disks or other suitable storage medium). In an embodiment, a database 114 may reside within media storage device 112. Also communicatively linked to the network 110 are a second computing device 104a (which may also referred to as a “first client device” or, when there is no specific mention of first computing device 102, the “first computing device”) and a third computing device 104b (also referred to as a “second client device” or, when there is no specific mention of first computing device 102, the “second computing device”). For the sake of example, it is assumed that a first user 106 operates second computing device 104a, and a second user 108 operates third computing device 104b. In some instances, the first user 106 and the second user 108 may be the same individual, while in other instances the first user 106 and the second user 108 may be different individuals. In an embodiment, each of computing devices 104a and 104b may execute client software 118a and 118b, respectively. An example implementation of client software 118a, 118b is a web browser. It should be understood that the networking environment may include any number of computing devices (e.g., hundreds of client devices) and the number depicted in FIG. 1 is meant only to be representative.

Also communicatively linked to the network 110 are a plurality of social network systems 120a through 120n (where “n” is an arbitrary number). In an embodiment, each of social network systems 120a through 120n may be a network-addressable computing system that is capable of hosting an online social network. Each social network system 120 may be accessed by computing devices 102, 104a, 104b by any suitable manner (e.g., either directly or via network 110). In one embodiment, each social network system 120 may include one or more servers (not shown) such as, for example, web servers, mail servers, message servers, file servers, application servers, proxy servers, and the like. Each social network system 120 may also include one or more data stores (not shown) that may be used to store various types of information. Such data stores may be relational databases, for example. In an embodiment, each social network system 120 may generate, send, receive, and store social networking data including, for example, user profile data, social graph information, and other suitable data associated with the online social network.

Computing devices 102, 104a, and 104b, and social network systems 120a through 120n may be communicatively connected to network 110 via one or more links 122. While the present disclosure contemplates any suitable links 122, in one or more embodiments, links 122 may be wireless links (e.g., Wi-Fi or Worldwide Interoperability for Microwave Access (WiMAX)), wireline links (e.g., Digital Subscriber Line (DSL) or Data Over Cable Service Interface Specification (DOC SIS)), or optical links (e.g., Synchronous Optical Network (SONET) or Synchronous Digital Hierarchy (SDH)). In some embodiments, one or more of links 122 may each include an intranet, extranet, ad hoc network, VPN, LAN, WLAN, WAN, a portion of the Internet, a cellular technology-based network, another link 122, or any suitable combination of two or more such links 122. Furthermore, each of computing devices 102, 104a, and 104b, and social network systems 120 need not necessarily be connected to network 110 via the same type of link 122.

It should be noted that computing devices 102, 104a, and 104b depicted in FIG. 1 are merely representative. While computing device 102 is depicted as a server and computing devices 104a and 104b are depicted as notebook computers, numerous other implementations of computing devices are also possible. For example, one or both of computing devices 104a and 104b may be a desktop computer, a tablet computer, or a smartphone.

Although FIG. 1 illustrates a particular arrangement of computing devices (e.g., computing devices 102, 104a, and 104b), social network systems (e.g., social network systems 120a through 120n), and network 110, the present disclosure contemplates any suitable arrangement of such computing devices, social network systems, and network. In an exemplary embodiment, and not by way of limitation, two or more of computing devices 102, 104a, and 104b and social network systems 120a through 120n may be connected to each other directly, bypassing network 110.

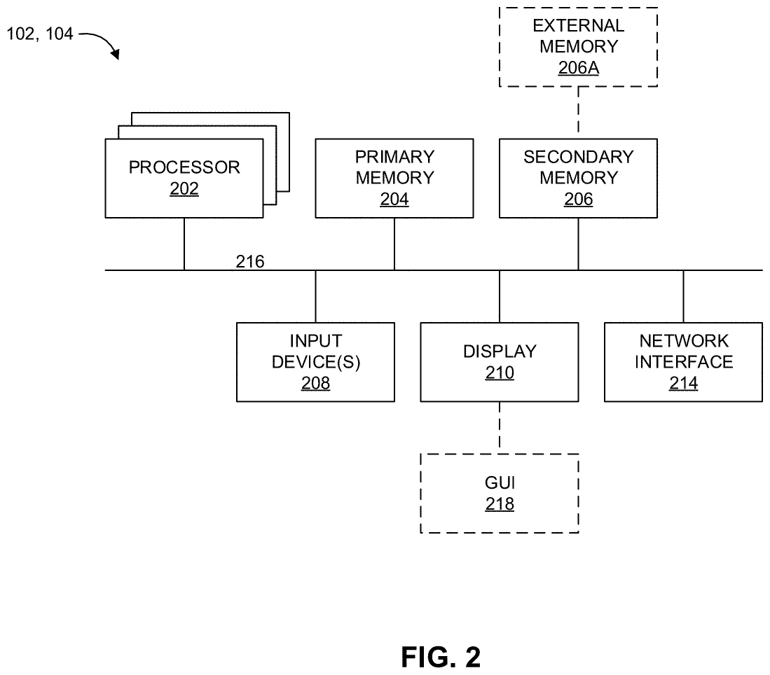

According to an embodiment, one or more of the computing devices of FIG. 1 (including media storage device 112) have the general architecture shown in FIG. 2. The device depicted in FIG. 2 includes one or more processors 202 (e.g., one or more microprocessors, controllers, or application-specific circuit), a primary memory 204 (e.g., volatile memory, random-access memory), a secondary memory 206 (e.g., non-volatile memory), one or more input devices 208 (e.g., keyboard, mouse, or touchscreen), a display (e.g., an organic, light-emitting diode display), and a network interface 212 (which may be wired or wireless). Memories 204 and 206 store instructions and data. The one or more processors 202 execute the instructions and use the data to carry out various procedures including, in some embodiments, the methods described herein.

Each of the elements of FIG. 2 is communicatively linked to one or more other elements via one or more data pathways 216. Possible implementations of the data pathways 216 include wires, conductive pathways on a microchip, and wireless connections. In an embodiment, processor 202 is one of multiple processors in the computing device, each of which is capable of executing a separate thread. In an embodiment, processor 202 communicates with other processors external to the computing device in order to initiate the execution of different threads on those other processors.

As used herein, “local memory” refers to one or both of memories 204 and 206 (i.e., memory accessible by processor 202 within the computing device). In some embodiments, secondary memory 206 is implemented as, or supplemented by an external memory 206A. Media storage device 112 is a possible implementation of external memory 206A. Processor 202 executes the instructions and uses the data to carry out various procedures including, in some embodiments, the methods described herein, including displaying a graphical user interface 218. Graphical user interface 218 is, according to one embodiment, software that processor 202 executes to display a report on display 210, and which permits a user to make inputs into the report via input devices 208.

In the exemplary embodiment of FIG. 1, computing devices 102, 104a, and 104b (e.g., processor 202 of each of the computing devices) are able to communicate with other devices of FIG. 1 via network interface 214 over network 110. In an embodiment, such communication occurs via a user interface that first computing device 102 provides to second computing device 104a and third computing device 104b. The specific nature of the user interface and what the user interface shows at any given time may vary depending what the user (e.g., user 106 or 108) has chosen to view. Also, multiple users may interact with different instances of the user interface on different devices. In some embodiments, first computing device 102 carries out calculations to determine how content is to be rendered on a computing device, generates rendering instructions based on those calculations, and transmits those rendering instructions to the computing device. Using the received instructions, the computing device (e.g., second computing device 104a and/or third computing device 104b) renders the content on a display (e.g., display 210). In other embodiments, first computing device 102 transmits instructions regarding an asset to a computing device. In carrying out the received instructions, the computing device performs the appropriate calculations locally to render the content of the asset on a display.

The following description of examples and embodiments may sometimes refer to one or more of client software 118a, client software 118b, first computing device 102, second computing device 104a, or third computing device 104b as taking one or more actions. It is to be understood that such actions may involve one or both of client software 118a and client software 118b taking such actions as: (a) the client software transmitting hypertext transport protocol commands such as “Get” and “Post” in order to transmit to or receive information from software running on first computing device 102 (e.g., via a web server), and (b) the client software running a script (e.g., JavaScript) to send information to and retrieve information from software running on first computing device 102. First computing device 102 may ultimately obtain information (e.g., web pages or data to feed into plugins used by the client software) from database 114. It should be understood, however, that when a computing device (or software executing thereon) carries out an action, it is processor hardware 202 (the main processor and/or one or more secondary processors, such as a graphics processing unit, hardware codec, input-output controller, etc.) that carries out the action at the hardware level.

In one or more embodiments, media storage device 112 may store data in one or more data structures 116. One possible implementation of data structure 116 is a social graph structure. For example, in an embodiment, first computing device 102 may obtain data about user accounts from one or more of social network systems 120a through 120n. Such data obtained from social network systems 120 may be stored in a social graph structure 116.

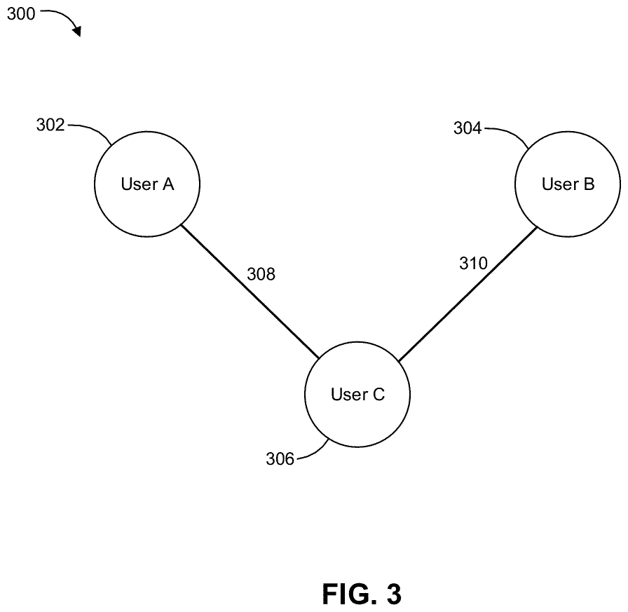

A social graph structure may include multiple nodes and multiple edges connecting the nodes. An example social graph structure 300 is illustrated in FIG. 3. As shown in FIG. 3, in particular embodiments, node 302 (representing “User A”), node 304 (representing “User B”), and node 306 (representing “User C”) are connected to one another by edges 308, 310.

In the following description of examples and embodiments, “user” and “user account” may sometimes be used interchangeably to refer to a specific user in a social network.

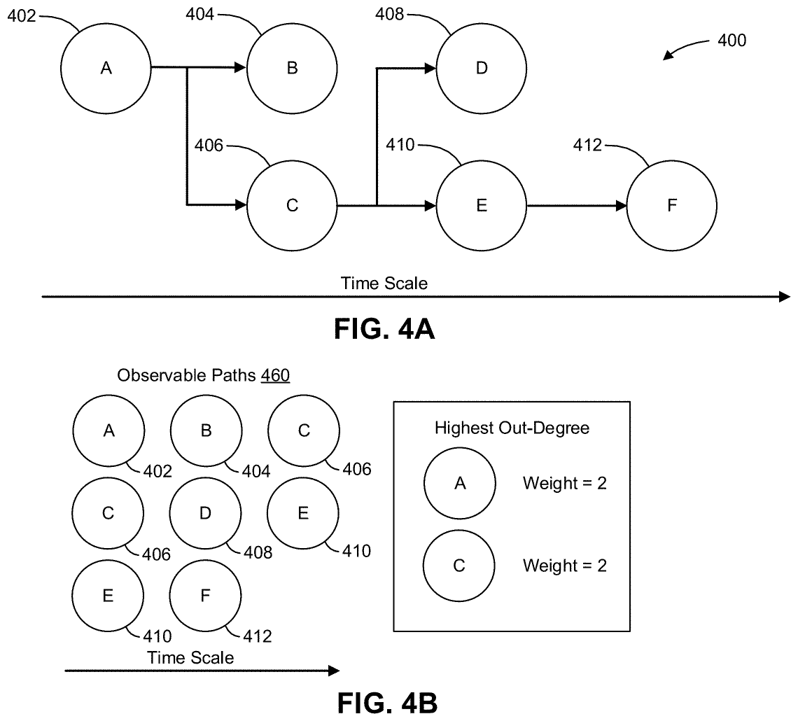

FIGS. 4A and 4B illustrate example sequences and information paths in an information spread event, according to an embodiment. FIG. 4A shows an example information spread event sequence 400 involving a plurality of nodes in a social network (e.g., one of social network systems 120a through 120n in FIG. 1). In the example sequence 400, information may pass from node 402 (which represents User A or User Account A) to both node 404 (which represents User B or User Account B) and node 406 (which represents User C or User Account C). For example, node 402 may create content (e.g., a post within the social network) that is then shared with node 404 and node 406, which may be connected to node 402 via edges (e.g., edges 308 and 310 in FIG. 3) in the social graph of node 402. In another example, the information that passes from node 402 to nodes 404 and 406 may be information that is created by another user account in the social network and relayed (e.g., reposted or reshared) by node 402 to nodes 404 and 406. Once node 406 obtains the information from node 402, node 406 may relay the information to node 408 (which represents User D or User Account D) and node 410 (which represents User E or User Account E). Nodes 408 and 410 may be connections of node 406 in the social graph of node 406. In addition, nodes 408 and 410 may also be connections of node 402 in the social graph of node 402. After node 410 obtains the information from node 406, node 410 may then relay the information to node 412 (which represents User F or User Account F). Node 412 may be a connection of node 410 in the social graph of node 410, and may also be a connection of node 406 in the social graph of node 406 and/or a connection of node 402 in the social graph of node 402. As shown, the flow of information from node 406 to nodes 408 and 410 occurs later in the sequence 400 than the flow of information from node 402 to nodes 404 and 406. Similarly, the flow of information from node 410 to node 412 occurs later in the sequence 400 than any of the other information flows in the sequence 400.

FIG. 4B illustrates the observable paths 460 of the information spread event based on the example sequence 400 shown in FIG. 4A and described above. For example, in the sequence shown in FIG. 4A, node 402 is neighbors with nodes 404 and 406, while node 404 is neighbors with nodes 402, 406, and 408. Thus, one possible information path in an information spread event might be from node 402 to node 406 to node 410 to node 412. Another possible information path in an information spread event might be from node 402 to node 404 to node 408 to node 410 to node 412. Other similar information paths are also possible, as shown in FIG. 4B.

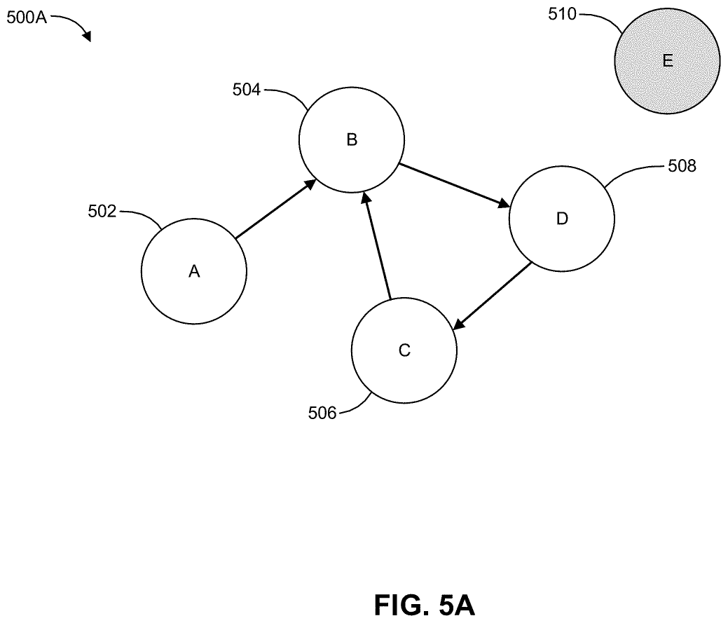

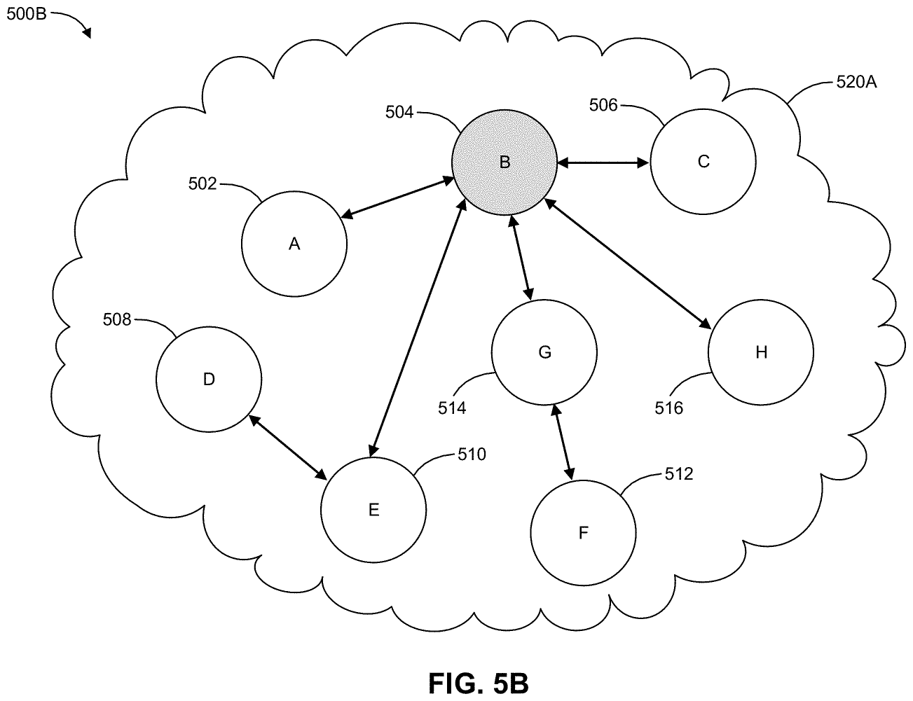

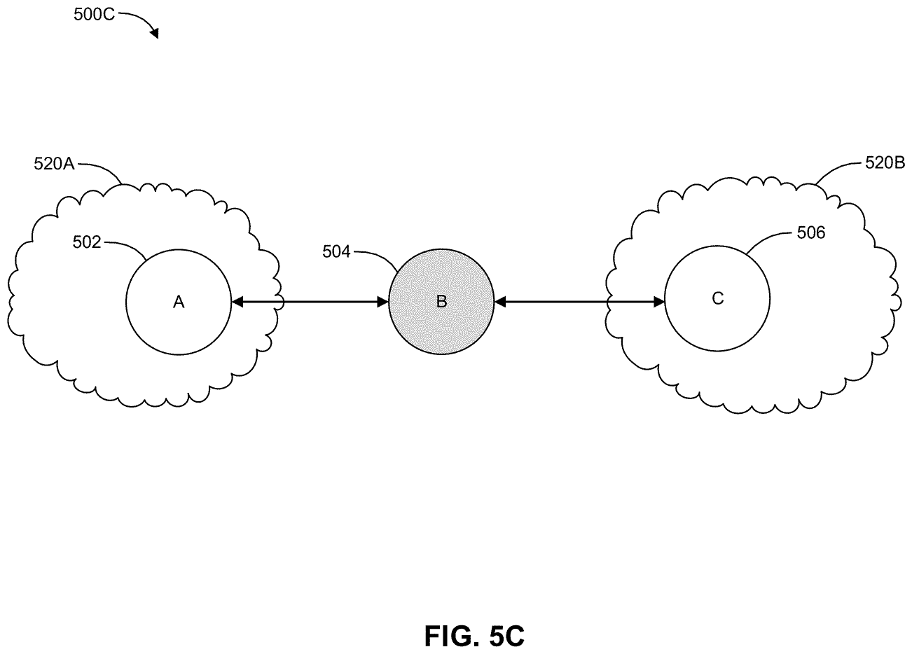

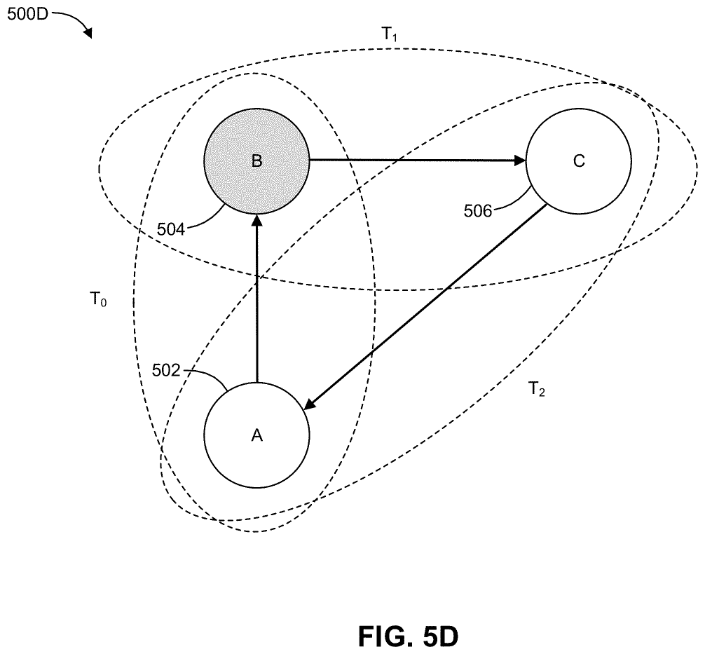

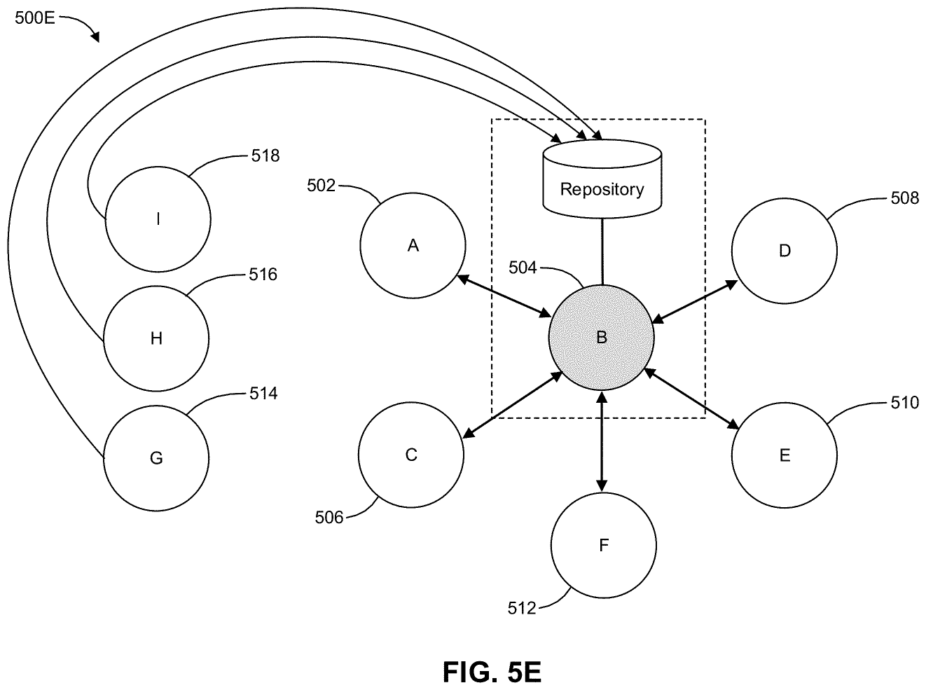

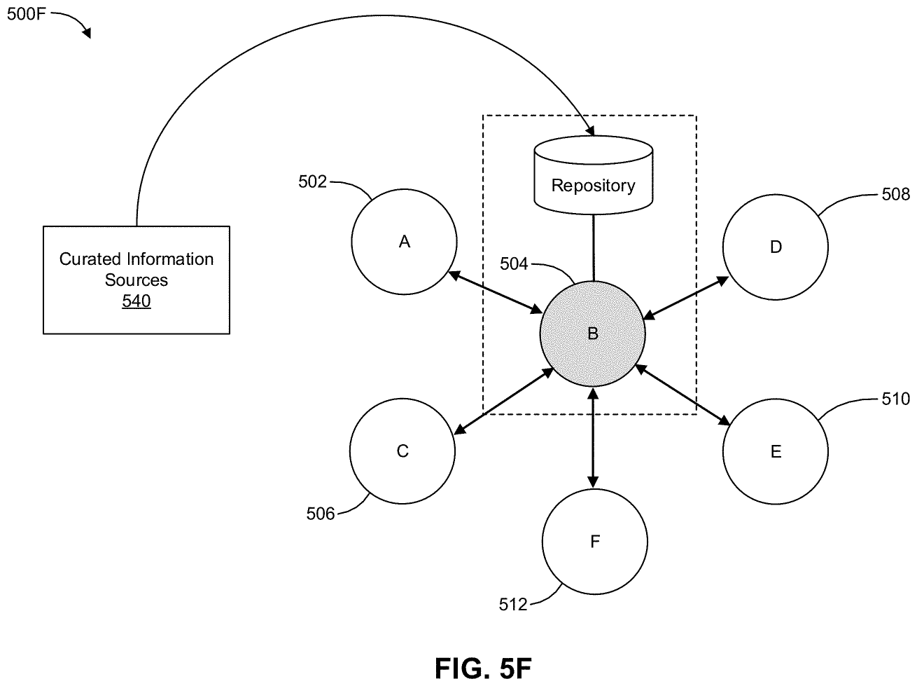

FIGS. 5A-5F are graphical representations of various actor types within a social network, according to one or more embodiments. FIG. 5A is a graphical representation of an “Isolate”. FIG. 5B is a graphical representation of a “Star”. FIG. 5C is a graphical representation of a “Bridge”. FIG. 5D is a graphical representation of a “Liaison”. FIG. 5E is a graphical representation of a “Maven”. FIG. 5F is a graphical representation of a “Salesman”.

FIG. 5 shows a graphical representation 500A of an “Isolate” actor type, in accordance with an embodiment. In the group of nodes shown in graphical representation 500A, node 510 is considered an isolate, as node 510 is unconnected and not communicating with any of nodes 502, 504, 506, and 508. For purposes of the present disclosure, an “isolate” may be defined as a user account (or user) in the social network who does not direct messages at any other particular user account, and who does not directly repeat (e.g., repost or forward) information created by any other user account. In an at least one embodiment, node 510 can be considered an isolate for graph 500A (the graph comprised of nodes 502, 504, 506, 508, and 510) if at no point in the past or future of the network does node 510 communicate with any other actor within the network.

FIG. 5B shows a graphical representation 500B of a “Star” actor type, in accordance with an embodiment. The star actor type may be considered a subclass of “Connectors,” which for purposes of the present disclosure may be defined as a user account in the social network that is quick to search their own knowledge base or their connections, for information. Connectors may have a large number of connections within the social network and are often willing to share these connections, thus becoming social bridges. As an example, a connector in a social network would typically have a lot of “friends” and be the direct recipient of a large number of messages. As will be described in greater detail below, the “Bridge” and “Liaison” actor types may also be considered subclasses of “Connectors.”

Referring again to the graph 500B shown in FIG. 5B, node 504 is considered a star within group 520A, where group 520A is comprised of nodes 502, 504, 506, 508, 510, 512, 514, and 516. As used herein, a “star” is a user account within a particular group (e.g., group 520A) of user accounts in the social network with the largest number of percentage based interactions. For example, in an embodiment, a star is a user account with the shortest paths between the majority of user accounts in a group (e.g., group 520A). This may be considered a measure of betweenness centrality when applied to the social network as a whole. Thus, the node with the highest betweenness centrality value (e.g., node 504) is considered the most central, or has the shortest path between the majority of nodes in the group.

FIG. 5C is a graphical representation of a “Bridge” actor type, in accordance with an embodiment. In graph 500C, node 504 is considered a bridge actor type. A bridge actor type is a user account that has relationships outside of a particular focal group of user accounts, and serves to connect that focal group to another focal group or to another individual user account. In the graph 500C, node 504 is connected to node 502 in group 520A and is also connected to node 506 in group 520B. In this manner, node 504 is a bridge that connects group 520A to group 520B. Unlike star actor types (e.g., node 504 in graph 500B, discussed above), a bridge actor type may have weak ties within the social network (e.g., connections to only two other user accounts), however the bridge actor type provides the shortest path between two distinct groups or individuals. In an embodiment, a user account may be said to be acting as a bridge when that user account is weakly connected within the social network, yet has a high betweenness centrality in the total social graph while at the same time connecting two or more groups.

FIG. 5D is a graphical representation of a “Liaison” actor type, in accordance with an embodiment. In graph 500D, node 504 is considered a liaison actor type. A liaison actor type is a user account that links many groups of users together through their individual connections. A liaison actor type provides the shortest path between groups. In an embodiment, a liaison actor type may also be considered a user account that introduces other user accounts to each other, or sets up connections on behalf of other user accounts. In graph 500D, node 502 connects to node 504 at a first time (T₀), node 504 subsequently connects to node 506 at a second time (T₁), and then node 506 connects to node 502 at a third time (T₂). In this manner, node 504 introduces node 506 to node 502. In one example, node 502 may need information from an unknown source, which is represented as node 506. Node 502 communicates this need for information to node 504. Node 504 then connects with node 506 in an effort to help node 502 obtain the desired information. As a result, node 504 connects node 506 to node 502.

FIG. 5E is a graphical representation of a “Maven” actor type, in accordance with an embodiment. In graph 500E, node 504 is considered a maven actor type. A maven actor type may be defined as a user account that other user accounts rely on for new information. For example, a maven actor type may be a user account that collects new information (e.g., from other sources or user accounts) and is willing to share that new information when asked. A maven actor type may collect information in an effort to solve a problem that they themselves are experiencing, but due their need to share and their above-average social and communication skills, they are able to efficiently pass on the knowledge they have gained. In general, a maven actor type will not stop after sharing information with only one other user account, but instead will continue to share the information over and over again with many other user accounts. In an embodiment, a maven actor type may be considered a user account that provides information (often in exchange for other information in return) to their connections in the social network upon request from a repository that the maven actor type has assembled from other user accounts. As shown in graph 500E, node 504 has bi-directional communications with nodes 502, 506, 508, 510, and 512, during which node 504 may provide information that node 504 has collected in a repository based on information shared with node 504 from nodes 514, 516, and 518.

FIG. 5F is a graphical representation of a “Salesman” actor type, in accordance with an embodiment. In graph 500F, node 504 is considered a salesman actor type. A salesman actor type is similar to a maven actor type, but with a few important differences. As a first example, as shown in graph 500F, the communication between node 504 and each of nodes 502, 506, 508, 510, and 512 is outward uni-directional (as opposed to the bi-directional communications between node 504 and nodes 502, 506, 508, 510, and 512 in graph 500E shown in FIG. 5E). The reason for this uni-directional communication is that a salesman actor type is marketing information rather than collecting information. Similarly, the information that is provided by node 504 to nodes 502, 506, 508, 510, and 512 is not information that was requested from node 504. Another example of a difference between a salesman actor type and a maven actor type is that the salesman actor type pulls information from a repository that generally consists of a single source (e.g., a maven actor type), rather than from multiple sources. As shown in graph 500F, node 504 provides information from a repository that has been built from curated sources 540, such as businesses, marketing literature, etc.

As discussed in greater detail below, an actor type associated with a particular user account may be used in determining an “impact score” for the user account. In an embodiment, a user's impact score is a probability that the user will participate in and have an impact on an information spread event that occurs in the social network.

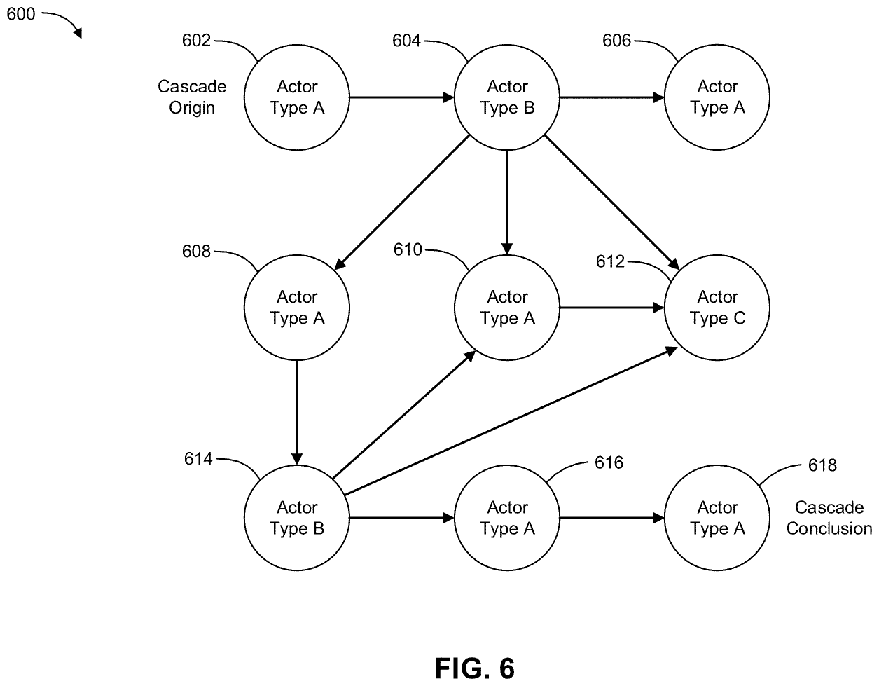

FIG. 6 illustrates an example observed information spread event, according to an embodiment. In the example information spread event 600, a node having “Actor Type A” is considered a salesman actor type (e.g., node 504 in graph 500F shown in FIG. 5F), a node having “Actor Type B” is considered a maven actor type (e.g., node 504 in graph 500E shown in FIG. 5E), and a node having “Actor Type C” is considered an isolate actor type (e.g., node 510 in graph 500A shown in FIG. 5A). As shown, the information spread event 600 begins with node 602 sharing information with node 604. Node 604 (which is a maven actor type) shares the information with nodes 606, 608, 610, and 612. In turn, node 608 shares the information with node 614 (also a maven actor type), who then shares the information with nodes 610, 612, and 616. Node 610 shares the information received from nodes 604 and 614 with node 612. The information spread event 600 concludes with node 616 sharing the information received from node 614 with node 618.

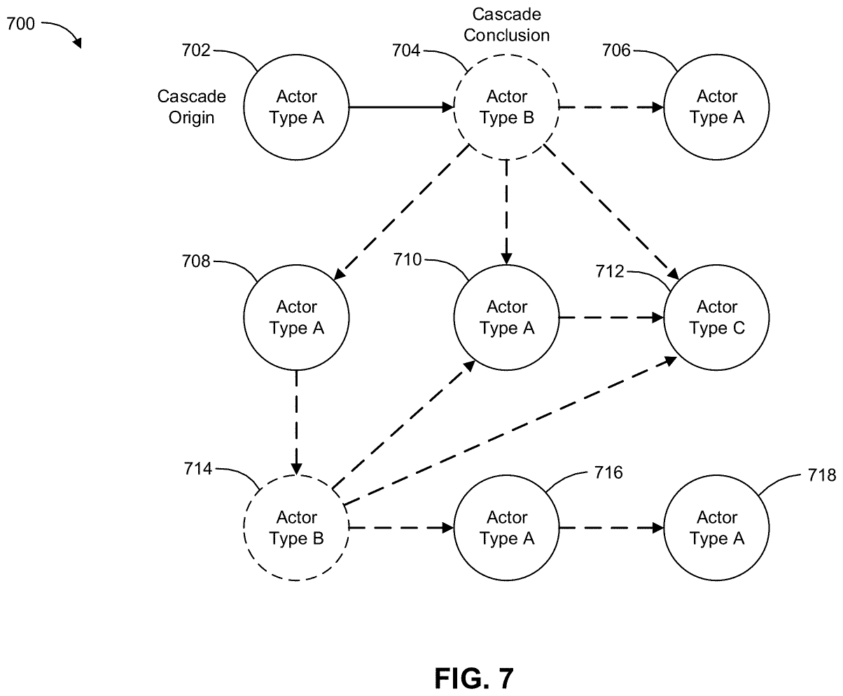

FIG. 7 illustrates an example information spread event with interruption, according to an embodiment. The nodes shown in FIG. 7 correspond to the nodes shown in FIG. 6, described above. However, in FIG. 7, nodes 704 and 714 (which are maven actor types) have been removed from the social graph. As a result, the information spread event 700 begins and ends with node 702 obtaining information. Because nodes 704 and 714 have been removed from the graph, the information does not finds its way to any of nodes 706, 708, 710, 712, 716, or 718. In this manner, the information spread event 700 (which would have otherwise been similar to the information spread event 600 shown in FIG. 6) is interrupted by the removal of key nodes 704 and 714.

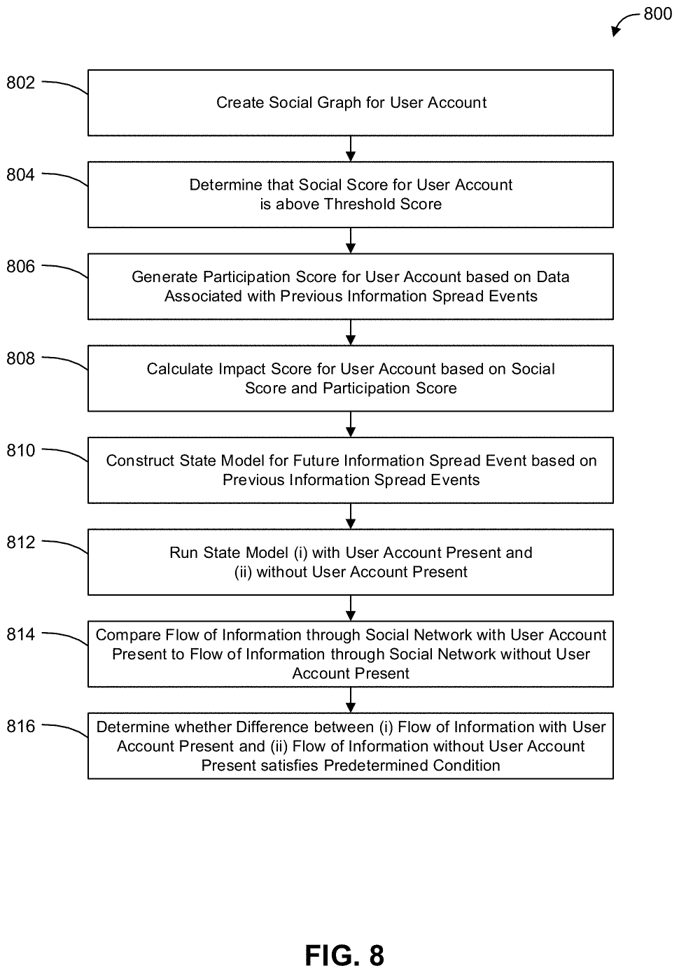

FIG. 8 is a flowchart illustrating an example method, implemented by data processing hardware, for analyzing data in a social network, according to an embodiment. In some embodiments, method 800 is implemented by first computing device 102 of FIG. 1, which interacts with social network systems 120 and computing devices 104a and 104b. FIG. 8 is described with reference to FIGS. 1 and 2 for explanatory purposes. In other embodiments, however, method 800 is implemented by another suitable computing device.

At block 802, first computing device 102 may create a social graph (e.g., data structure 116 in FIG. 1) for a user account associated with a social network (e.g., one of social network systems 120 in FIG. 1). In one embodiment, the social graph created for the user account may be stored in media storage device 112 as a nested JavaScript Object Notation (JSON) Object. The social graph for the user account may be created based on various data about the user account obtained from the social network. Possible examples of the type of data that may be obtained or received from the social network to create the social graph for the user account include data about the user account's friends in the social network, followers in the social network, mentions of the user account by other user accounts, mentions about other user accounts from the user account, other user accounts who “liked” or reacted to a post by the user account, and the like.

At block 804, the first computing device 102 may determine that a social score for the user account is above a threshold score. In one embodiment, the social score for the user account may be based on the social graph that was created for the user account in block 802. For example, the social score for the user account may be based on one or more characteristics of the social graph created for the user account, such as degree centrality (e.g., In-Degree of connections, Out-Degree of connections, etc.) of the user account in the social network, frequency of posting content in the social network by the user account, and/or frequency of reposting, by the user account, content posted by other user accounts in the social network. In one embodiment, the social score for the user account may also be based on or reflect other information about the user account such as, for example, the time(s) of day (specific to the time zone of the user account) that the user account is most frequently posting content (which can be interpreted as an indicator of how likely the user account's posts are seen by others), and also the complexity (e.g., Shannon's ideal entropy) of the speech being used by the user account when posting new content.

At block 806, the first computing device 102 may generate (e.g., determine, calculate, etc.) a participation score for the user account based on data associated with one or more previous information spread events in the social network. In an embodiment, the data associated with the one or more previous information spread events may include data about participation by the user account in the one or more previous information spread events. Such data may include, for example, data about whether the user account created content about the previous event or relayed content created by others about the event, whether the content created or relayed by the user account was subsequently relayed by others within the user account's connections (Out-degree), etc. Such data can be understood as being an indicator of how “trusted” the user account is by other user accounts in the social network as a reliable source of information.

At block 808, the first computing device 102 may calculate an impact score (“measurement of impact”) for the user account based on the social score for the user account (e.g., determined at block 804) and the participation score for the user account (e.g., calculated at block 806). In one embodiment, the impact score for the user account may be a probability that the user account will participate in and have an impact on a future information spread event. For example, in an embodiment, the social score for the user account can be understood as representing a possible reach of the user account within the social network (e.g., the extent to which information created or relayed by the user account may flow through other connected user accounts), while the participation score for the user account can be understood as representing a likelihood that the user account will participate in an information spread event given a certain topic or subject matter. In an embodiment, the social score for the user account and the participation score for the user account may be multiplied (with or without any sort of weight factor) to arrive at the impact score for the user account, which can be understood as representing a probability of impact of the user account.

At block 810, the first computing device 102 may construct a state model (e.g., state model 600 of FIG. 6) for a future information spread event in the social network. As described above with respect to FIGS. 6 and 7, in some embodiments, the state model represents the social network at a plurality of different states of the future information spread event. In an embodiment, the state model constructed at block 810 may be based on the one or more previous information spread events in the social network in which the user account participated. For example, data from the previous information spread events may be used to determine that a future information spread event similar (e.g., in subject matter, timing, etc.) to the previous information spread events will flow in a specific order and include participation by specific user accounts in the social network.

At block 812, the first computing device 102 may run (e.g., execute) the state model created at block 810 both with the user account present in the state model and without the user account present in the state model.

At block 814, the first computing device 102 may compare a flow of information through the social network with the user account present in the state model to a flow of information through the social network without the user account present in the state model. At block 816, the first computing device 102 may determine, based on the comparison performed at block 814, whether a difference between the flow of information through the social network with the user account present in the state model and the flow of information through the social network without the user account present in the state model satisfies a predetermined condition. In an embodiment, the comparison and determination made by the first computing device 102 at blocks 814 and 816, respectively, may include comparing a first length of time it takes for the information to flow through the plurality of different states of the future information spread event with the user account present in the state model to a second length of time it takes for the information to flow through the plurality of different states of the future information spread event without the user account present in the state model; and determining from the comparison whether a difference between the first length of time and the second length of time is above a threshold length of time.

For the purposes of promoting an understanding of the principles of the disclosure, reference has been made to the embodiments illustrated in the drawings, and specific language has been used to describe these embodiments. However, no limitation of the scope of the disclosure is intended by this specific language, and the disclosure should be construed to encompass all embodiments that would normally occur to one of ordinary skill in the art. Descriptions of features or aspects within each embodiment should typically be considered as available for other similar features or aspects in other embodiments unless stated otherwise. The terminology used herein is for the purpose of describing the particular embodiments and is not intended to be limiting of exemplary embodiments of the disclosure. In the description of the embodiments, certain detailed explanations of related art are omitted when it is deemed that they may unnecessarily obscure the essence of the disclosure.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. A method for analyzing data in a social network, the method comprising:
creating, using data processing hardware, a social graph for a user account associated with a social network;
determining, by the data processing hardware, that a social score for the user account is above a threshold score, wherein the social score for the user account is based on the social graph created for the user account;
generating, by the data processing hardware, a participation score for the user account based on data associated with one or more previous information spread events in the social network;
calculating, by the data processing hardware, an impact score for the user account based on the social score for the user account and the participation score for the user account;
constructing, by the data processing hardware, a state model for a future information spread event in the social network, wherein the state model is based on the one or more previous information spread events in the social network;
running, using the data processing hardware, the state model (i) with the user account present and (ii) without the user account present;
comparing, by the data processing hardware, a flow of information through the social network with the user account present in the state model to a flow of information through the social network without the user account present in the state model; and
determining, by the data processing hardware, whether a difference between (i) the flow of information through the social network with the user account present in the state model and (ii) the flow of information through the social network without the user account present in the state model satisfies a predetermined condition.

2. The method of claim 1, further comprising:
determining, by the data processing hardware, the social score for the user account based on one or more characteristics of the social graph created for the user account.

3. The method of claim 2, wherein the one or more characteristics of the social graph created for the user account includes one or more of (i) degree centrality of the user account in the social network, (ii) frequency of posting content in the social network by the user account, and (iii) frequency of reposting, by the user account, content posted by other user accounts in the social network.

4. The method of claim 1, wherein the data associated with the one or more previous information spread events includes data about participation by the user account in the one or more previous information spread events.

5. The method of claim 1, wherein the state model represents the social network at a plurality of different states of the future information spread event.

6. The method of claim 5, wherein comparing a flow of information through the social network with the user account present in the state model to a flow of information through the social network without the user account present in the state model comprises:
comparing a first length of time it takes for the information to flow through the plurality of different states of the future information spread event with the user account present in the state model to a second length of time it takes for the information to flow through the plurality of different states of the future information spread event without the user account present in the state model.

7. The method of claim 1, wherein the impact score for the user account is a probability that the user account will participate and have an impact in the future information spread event.

8. A system comprising:
data processing hardware; and
memory hardware in communication with the data processing hardware and storing instructions that when executed on the data processing hardware cause the data processing hardware to perform operations comprising:
creating a social graph for a user account associated with a social network;
determining that a social score for the user account is above a threshold score, wherein the social score for the user account is based on the social graph created for the user account;
generating a participation score for the user account based on data associated with one or more previous information spread events in the social network;
calculating an impact score for the user account based on the social score for the user account and the participation score for the user account;
constructing a state model for a future information spread event in the social network, wherein the state model is based on the one or more previous information spread events in the social network;
running the state model (i) with the user account present and (ii) without the user account present;
comparing a flow of information through the social network with the user account present in the state model to a flow of information through the social network without the user account present in the state model; and
determining whether a difference between (i) the flow of information through the social network with the user account present in the state model and (ii) the flow of information through the social network without the user account present in the state model satisfies a predetermined condition.

9. The system of claim 8, the operations further comprising:
determining the social score for the user account based on one or more characteristics of the social graph created for the user account.

10. The system of claim 9, wherein the one or more characteristics of the social graph created for the user account includes one or more of (i) degree centrality of the user account in the social network, (ii) frequency of posting content in the social network by the user account, and (iii) frequency of reposting, by the user account, content posted by other user accounts in the social network.

11. The system of claim 8, wherein the data associated with the one or more previous information spread events includes data about participation by the user account in the one or more previous information spread events.

12. The system of claim 8, wherein the state model represents the social network at a plurality of different states of the future information spread event.

13. The system of claim 12, wherein comparing a flow of information through the social network with the user account present in the state model to a flow of information through the social network without the user account present in the state model comprises:
comparing a first length of time it takes for the information to flow through the plurality of different states of the future information spread event with the user account present in the state model to a second length of time it takes for the information to flow through the plurality of different states of the future information spread event without the user account present in the state model.

14. The system of claim 8, wherein the impact score for the user account is a probability that the user account will participate and have an impact in the future information spread event.

15. A non-transitory computer-readable storage medium including instructions that, when executed by at least one processor of a computing device, cause the computing device to perform operations comprising:
creating a social graph for a user account associated with a social network;
determining that a social score for the user account is above a threshold score, wherein the social score for the user account is based on the social graph created for the user account;
generating a participation score for the user account based on data associated with one or more previous information spread events in the social network;
calculating an impact score for the user account based on the social score for the user account and the participation score for the user account;
constructing a state model for a future information spread event in the social network, wherein the state model is based on the one or more previous information spread events in the social network;
running the state model (i) with the user account present and (ii) without the user account present;
comparing a flow of information through the social network with the user account present in the state model to a flow of information through the social network without the user account present in the state model; and
determining whether a difference between (i) the flow of information through the social network with the user account present in the state model and (ii) the flow of information through the social network without the user account present in the state model satisfies a predetermined condition.

16. The non-transitory computer-readable storage medium of claim 15, the operations further comprising:
determining the social score for the user account based on one or more characteristics of the social graph created for the user account.

17. The non-transitory computer-readable storage medium of claim 16, wherein the one or more characteristics of the social graph created for the user account includes one or more of (i) degree centrality of the user account in the social network, (ii) frequency of posting content in the social network by the user account, and (iii) frequency of reposting, by the user account, content posted by other user accounts in the social network.

18. The non-transitory computer-readable storage medium of claim 15, wherein the data associated with the one or more previous information spread events includes data about participation by the user account in the one or more previous information spread events.

19. The non-transitory computer-readable storage medium of claim 15, wherein the state model represents the social network at a plurality of different states of the future information spread event.

20. The non-transitory computer-readable storage medium of claim 19, wherein comparing a flow of information through the social network with the user account present in the state model to a flow of information through the social network without the user account present in the state model comprises:
comparing a first length of time it takes for the information to flow through the plurality of different states of the future information spread event with the user account present in the state model to a second length of time it takes for the information to flow through the plurality of different states of the future information spread event without the user account present in the state model.
